(19) United States
(12) Patent Application Publication
(10) Pub. No.: US 2025/0232337 A1
(43) Pub. Date: Jul. 17, 2025

(54) System and Method for Providing Marketing Consent Synchronization Across Multiple Third Party SaaS Integrations

(71) Applicant: Constant Contact Inc., Waltham, WA (US)

(72) Inventors: Srinivas Subramanyam Pulugurtha, Waltham, MA (US); Pritish Prashant Pai, Waltham, MA (US); Misha Smirnov, Waltham, MA (US); Juan Yin, Waltham, MA (US); Fang Xie, Waltham, MA (US); Nishad Sadasivan, Waltham, MA (US); Marc Schaedle, Waltham, MA (US)

(21) Appl. No.: 19/019,288

(22) Filed: Jan. 13, 2025

Related U.S. Application Data
(60) Provisional application No. 63/619,769, filed on Jan. 11, 2024.

(51) Int. Cl. G06Q 30/0241; G06F 16/27

(52) U.S. Cl. CPC G06Q 30/0277; G06F 16/27

(57) ABSTRACT

A computer-based method for providing electronic communication marketing consent synchronization across multiple third-party Software as a Service (SaaS) integrations, includes a synchronization module communicating with a first SaaS platform requesting a list of customers that have authorized electronic communication with the first SaaS platform, wherein the list of customers includes for at least one customer a level of consent to electronic communications from the first SaaS provider. The first SaaS platform then transmits the list of customers to the synchronization module after which the synchronization module transmits the customer consent received from the first SaaS platform to at least one other SaaS platform.

### CROSS-REFERENCE TO RELATED APPLICATIONS

The present utility patent application claims priority to, and the benefit of, U.S. Provisional Patent Application No. 63/619,769, entitled “System and Method for Providing Marketing Consent Synchronization Across Multiple Third Party SaaS Integrations”, filed on Jan. 11, 2024, which is incorporated herein by reference in its entirety.

### FIELD OF THE INVENTION

The present invention relates to obtaining consent for online communications, and more particularly, is related to bidirectional synchronization of marketing consent based on workflows.

### BACKGROUND OF THE INVENTION

Electronic communication has come a long way, with many different forms of communication currently available, examples including, but not being limited to, electronic mail (email) and short text messaging, to name only two of many. Email, for example, is very easy to use as a marketing tool and email campaigns are often made and directed toward an email list, in the hopes of increasing sales and bringing familiarity to services and goods. Unfortunately, due to ease in using email for communication, companies and individuals abuse use, resulting in the public receiving excessive unwanted email and text communications, among other unwanted communications. This is one reason why laws have been implemented to regulate the electronic communication industry.

Due to such laws, those seeking to use email marketing, for example, will seek electronic consent from customers to provide such electronic marketing. Unfortunately, as different Software as a Service (SaaS) platforms are used for the sale of products and services, multiple requests for electronic communication permission may be sought for the same individual, thereby increasing chances of the customer rejecting the permission previously provided. In general, an increase in consent requests to a single customer, increases the chances that consent will be removed by the customer. Such additional consent seeking can be detrimental to a successful business. As a result, businesses are confronted with the obstacle of obtaining customer authorizations, while avoiding rejection of communication permission, while customers are bombarded with communication authorization requests.

Therefore, there is a need in the industry to address the abovementioned shortcomings.

### SUMMARY OF THE INVENTION

Embodiments of the present invention provide a method and system for providing marketing consent synchronization across multiple third-party Software as a Service (SaaS) integrations. Briefly described, the present invention is directed to a computer-based method for providing electronic communication marketing consent synchronization across multiple third-party SaaS integrations, including a synchronization module communicating with a first SaaS platform requesting a list of customers that have authorized electronic communication with the first SaaS platform, wherein the list of customers includes for at least one customer a level of consent to electronic communications from the first SaaS provider. The first SaaS platform then transmits the list of customers to the synchronization module after which the synchronization module transmits the customer consent received from the first SaaS platform to at least one other SaaS platform.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a block diagram illustrating a network 100 in which the present system and method may be provided.

FIG. 2 is a schematic diagram illustrating an embodiment of the present synchronization system in further detail.

FIG. 3 is a flowchart illustrating the general process used by the present synchronization system.

FIG. 4 is a flowchart illustrating steps taken by the synchronization system during the providing of marketing consent synchronization.

FIG. 5 is a flowchart that is a continuation of FIG. 4, illustrating steps taken by the synchronization system during the providing of marketing consent synchronization.

### DETAILED DESCRIPTION

The present system and method optimizes email traffic, short-text messaging traffic, and other electronic messaging traffic to provide maximum disclosure and sales for a company, using a list of contacts, associated contact information, and electronic communication consent records, while not violating laws in the electronic communication field intended to minimize unwanted communications.

Marketing consent is updated in near real-time through real-time extraction from third-party transactions (for example, ecommerce). First party site-owner declarations are combined in the present system and method with first party opt-outs to electronic marketing and third-party derived subscriber preferences, so as to provide an accurate and current customer electronic messaging authorization. Third-party derived subscriber preferences may be determined from, for example, but not limited to, shopping cart opt-ins of a first party. A first party site-owner declaration is a statement from a marketer declaring, for example, that the marketer has the authorization to market to a customer because the customer explicitly provided the marketer with electronic communication authorization. Such first party site-owner declaration may also provide levels of consent provided to the marketer, as explained hereinafter.

Reference will now be made in detail to embodiments of the present invention, examples of which are illustrated in the accompanying drawings. Wherever possible, the same reference numbers are used in the drawings and the description to refer to the same or like parts.

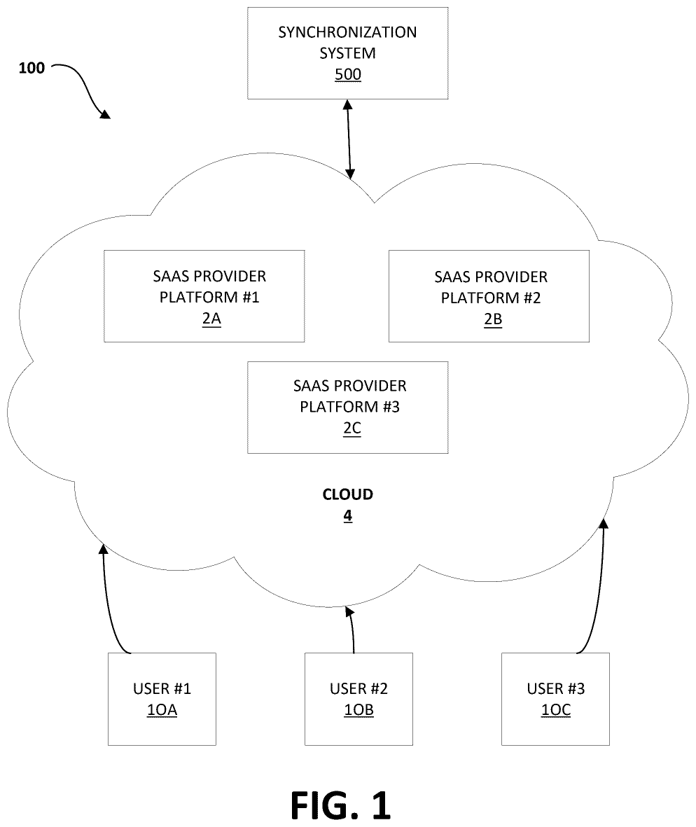

FIG. 1 is a block diagram illustrating a network 100 in which the present system and method may be provided. Marketers having their own site (for example, but not limited to, a marketer website or funnel), typically use multiple software as a service (SaaS) providers to provide services or sell products via their site. For example, a SaaS provider may be Shopify, where the Shopify platform allows a marketer to sell a product or service of the marketer to a customer using features of the Shopify platform, such that Shopify is the SaaS provider for the marketer. A marketer may also use the SaaS provider without their own private marketer site, but instead, using the SaaS provider to create a site for selling their product or service, or simply using a SaaS provider site for selling the marketer product or service. Multiple different configurations of marketer and SaaS provider relationships may exist, each of which is intended to be included within the present description. It is also noted, that while the present description provides the example of the marketer site being, for example, a marketer Website or funnel, other marketer sites may be used through which the marketer can market and/or offer to sell their product or service.

FIG. 1 illustrates several of these SaaS provider software platforms 2A, 2B, 2C located within a cloud environment 4. As is known by those having ordinary skill in the art, a cloud environment is a virtualized space accessible over the internet where computing resources like servers, storage, and applications can be accessed on-demand, allowing users to utilize services without managing physical hardware, essentially providing a network of remote servers that can be accessed from anywhere with an internet connection. This includes different cloud deployment models like public, private, and hybrid clouds, each with varying levels of access and control depending on the service provider and user needs.

As shown by FIG. 1, there are several users, or customers 10A, 10B, 10C who interact with a SaaS provider software platform 2A, 2B, 2C to make a purchase of a product or service, via an electronic device. Such electronic devices may be, but are not limited to, mobile phones, portable computers, such as, but not limited to, laptops, desktop computers, or other electronic devices. During purchase of the product or service, the SaaS platform 2A, 2B, 2C, such as, for example, but not limited to, Shopify, obtains consent of the customer to send electronic communications from the site owner, or marketer, to the customer. Such electronic communications may be, for example, but not limited to, electronic mail, SMS (short message service) messaging, or another electronic communication service. The SaaS providers typically have a double-opt-in for SMS messaging, where a customer may have to respond twice prior to when marketing to an email or SMS address of the customer can be performed.

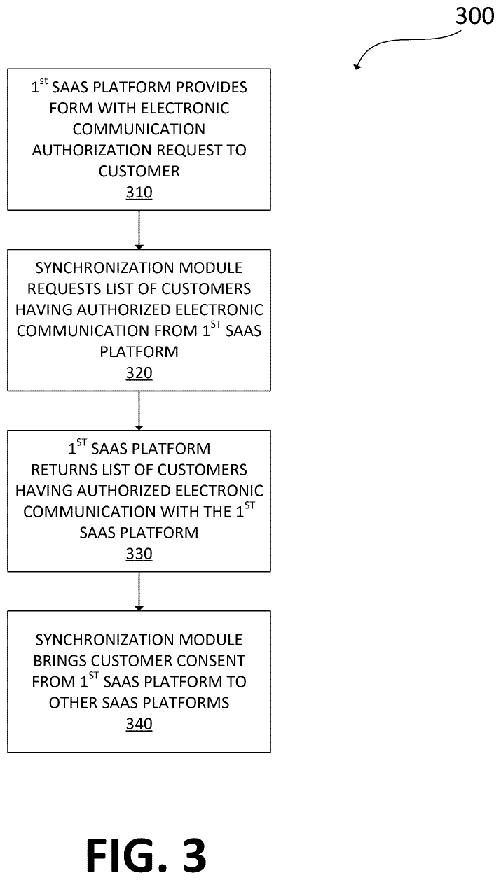

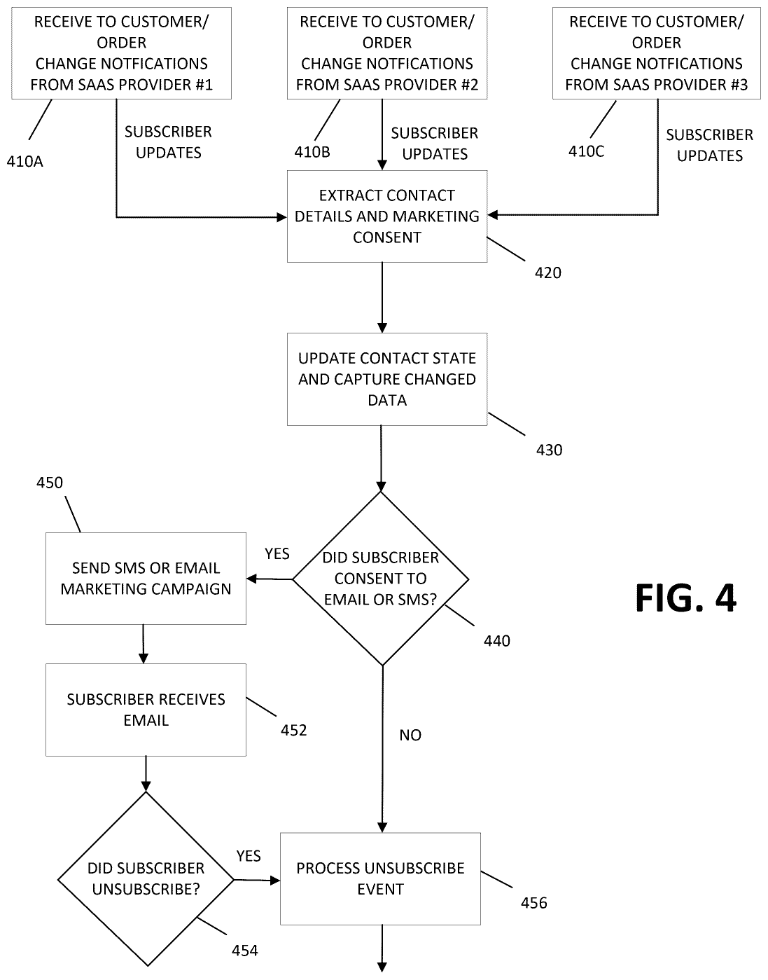

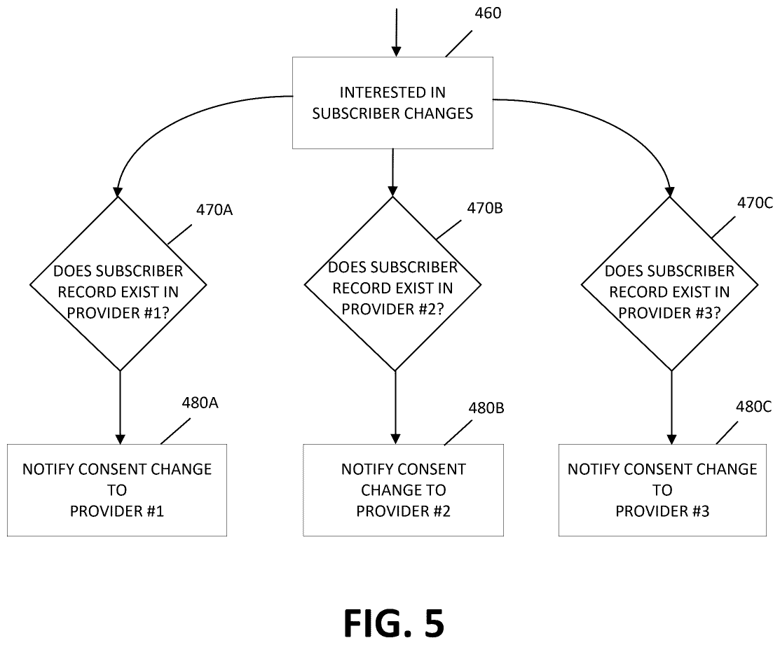

A synchronization system 500 is located within the network 100 and receives customer consent and opt-out information from the SaaS provider platforms 2A, 2B, 2C, preferably, in real-time. This process is described in greater detail with regard to FIG. 3, FIG. 4, and FIG. 5.

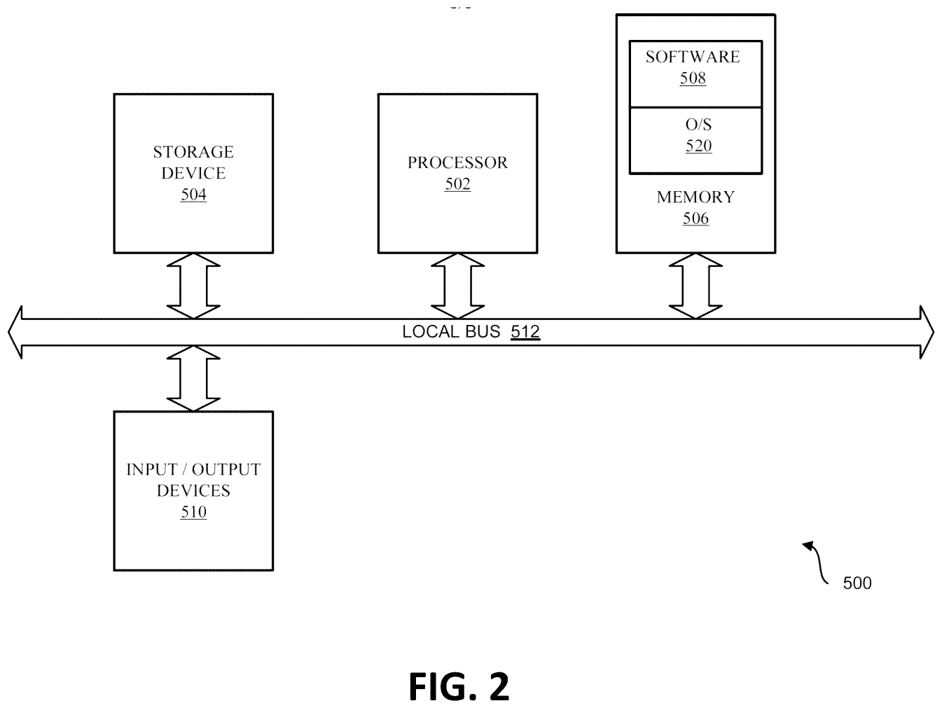

If a different platform, also referred to herein as a secondary platform, is used by the marketer to offer products or services to the public, customer consent may be needed from the secondary platform as well. In FIG. 1, the secondary platform may be, for example, SaaS provider 2B, which is located within the cloud 4. An example of this different platform may be a product or service review platform. In this case, the review platform 2B may not be aware that the customer 10A has previously provided electronic communication consent via the first SaaS platform 2A, and therefore, the review platform 2B also seeks consent from the customer 10A for the forwarding of marketing electronic communications. While the second platform 2B may allow for uploading of a consent list, the second platform 2B typically does not have the ability to synchronize the consent list with a current list. This is resolved by the present synchronization system 500 of FIG. 1, and further illustrated by FIG. 2.

In accordance with the present system and method, the synchronization system 500 used within the network 100 makes it so that receiving multiple consent requests for a customer to receive electronic communication is no longer necessary. This removes a point of tension between a marketer and a potential customer, where the customer could have otherwise decided not to receive electronic communication from the marketer after receiving an additional request for electronic communication consent from a second SaaS platform.

The present system and method, through use of the present synchronization system 500, instead synchronizes consent and withdrawal of consent from a customer for electronic communication between multiple SaaS platforms, so that additional consent and withdrawal of consent is not required. The present system and method provides for electronic marketing management from one place, thereby increasing efficiency in electronic marketing campaigns.

An application programming interface (API) is provided and used to allow the SaaS platforms 2A, 2B, 2C to communicate with the present synchronization system 500. As is known by those having ordinary skill in the art, an API is a software interface that allows two or more computer programs to communicate with each other. The SaaS API of the present synchronization system 500, as provided within the memory, or alternatively, as provided within a separate logical device within the synchronization system 500 that may communicate with the memory, allows for the transfer of data between the SaaS platforms 2A, 2B, 2C, and specifically, in the present system and method, the exchange of electronic communication consent information between SaaS platforms 2A, 2B, 2C and the present synchronization system 500.

The present synchronization system 500 may be a computer, an example of which is shown in the schematic diagram of FIG. 2. The synchronization system 500 contains a processor 502, a storage device 504, a memory 506 having software 508 stored therein that defines the abovementioned and below mentioned functionality for synchronization (e.g., memory module), input, and output (I/O) devices 510 (or peripherals), and a local bus, or local interface 512 allowing for communication within the synchronization system 500. The memory 506 defines functionality allowing it to function as an API as described herein, which provides for the transfer of data between SaaS platforms 2A, 2B, 2C.

The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present synchronization system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system synchronization 500, as described below. The memory 506 may contain an operating system (O/S) 520. The operating system essentially controls the execution of programs within the synchronization system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the synchronization system 500 is in operation, the processor 502 is configured to execute the software 508 stored within the memory 506, to communicate data to and from the memory 506, and to generally control operations of the synchronization system 500 pursuant to the software 508, as explained above.

When the functionality of the synchronization system 500 is in operation, the processor 502 is configured to execute the software 508 stored within the memory 506, to communicate data to and from the memory 506, and to generally control operations of the synchronization system 500 pursuant to the software 508. The operating system 520 is read by the processor 502, perhaps buffered within the processor 502, and then executed.

When the synchronization system 500 is implemented in software 508, it should be noted that instructions for implementing the synchronization system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method.

Instructions for implementing the synchronization system 500 can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted, or otherwise processed in a suitable manner if necessary, and then stored in a computer memory.

In an alternative embodiment, where the synchronization system 500 is implemented in hardware, the synchronization system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the description and figures.

FIG. 3, FIG. 4, and FIG. 5 are flowcharts illustrating an exemplary embodiment of the present invention where the synchronization system is used to providing marketing consent synchronization across multiple third-party SaaS integrations. The flowchart 300 of FIG. 3 illustrates the general process used by the present synchronization system 500. As shown by block 310, a first SaaS platform 2A (FIG. 1) provides a form to a customer, where a field of the form asks whether the customer can be marketed to via electronic communication. As an example, if the customer selects yes on the form, they can be marketed to via electronic communication, the SaaS platform may forward an email to the customer welcoming them to the services of the SaaS platform and letting the customer know that if they do not wish to subscribe to electronic messaging, then they can unsubscribe. In addition, for SMS messaging, there typically is a requirement for a response back from the customer confirming that yes they do want SMS messaging. At this point, the SaaS platform, such as, Shopify which is a SaaS ecommerce platform, has captured consent.

One having ordinary skill in the art will appreciate that the form provided to the customer for obtaining authorization, may be in one of many different configurations. For example, the form may be dedicated only to obtaining authorization, or in the alternative, the form may simply have a field within the entire form dedicated to obtaining authorization for electronic communication, while other fields within the form are dedicated to other purposes, so as to not have an entire form dedicated to only obtaining authorization for electronic communication.

In accordance with the present invention, it is beneficial for the consent authorization to be for more than just the first SaaS platform 2A (FIG. 1), such that the consent captured is one that is for the receiving of electronic communications from multiple third parties, and not just one SaaS platform. By having a broader consent, this opens such consent to be used by the present system and method by multiple SaaS platforms that would require consent for electronic communication. Of course, one having ordinary skill in the art would appreciate that alternatively, the consent authorization form may be dedicated to a single SaaS platform. However, it is noted that by having a single form authorizing electronic communication for multiple SaaS platforms, the need for the other SaaS platforms to individually seek authorization is removed.

As shown by block 320, the synchronization module 500 communicates with the first SaaS platform 2A (FIG. 1) requesting a list of customers that have authorized electronic communication. In response, the SaaS platform 2A (FIG. 1) returns to the synchronization module 500 (FIG. 1) a list of customers that have authorized electronic communication with the first SaaS platform 2A (FIG. 1) (block 330). This list of customers that have authorized electronic communication with the first SaaS platform 2A may be stored within the storage device 504 (FIG. 2). It should be noted that the storage device 504 (FIG. 2) may also have stored therein the first party site-owner declarations, which, as previously stated, is the statement from a marketer declaring, for example, that the marketer has the authorization to market to a customer because the customer explicitly provided the marketer with electronic communication authorization. The first party site-owner declaration may also provide levels of consent provided to the marketer.

The list of customers includes identification information of each customer on the list and a level of consent for electronic communication associated with each customer, that is specific to that customer. Of course, listing the level of consent for each and every customer is not required in accordance with the present invention. Different levels of consent may specify for a specific customer, which SaaS platforms consent is provided for, as previously designated by the customer, and may also provide different levels of consent within a SaaS platform based on other factors. As a non-limiting example, a single SaaS platform may have multiple services that are available within the SaaS platform, where different consent levels provide access to different levels of services within the SaaS platform. In addition, a single SaaS provider may contain multiple SaaS platforms, where different levels of consent provide access to different SaaS platforms of the SaaS provider. Specifically, consent levels may specify access levels to services of a SaaS platform and/or SaaS platforms of a SaaS provider. Any combination of the two may be provided. The list of customers returned may be provided in the form of individual records or a comprehensive record.

As shown by block 340, the synchronization module 500 (FIG. 1) then transmits the customer consent received from the first SaaS platform 2A (FIG. 1), to other SaaS platforms automatically, so as to alleviate the need of obtaining additional customer permissions for electronic communication from SaaS platforms that are not the original SaaS platform from which authorization was requested and obtained. This is especially effective if within the requested authorization of the customer, the customer provided electronic communication permission for multiple SaaS platforms 2A, 2B, 2C. Alternatively, the level of consent provided by the customer may be such that multiple SaaS platforms would be covered by the consent, in which case sharing of the customer consent from a first SaaS platform 2A, by the synchronization module 500 (FIG. 1), to the second SaaS platform 2B that is included within the customer consent, would result in the second SaaS platform 2B not requesting additional consent from the customer because consent has already been provided by the customer and shared by the synchronization module 500 (FIG. 1) from the first SaaS platform 2A to the second SaaS platform 2B.

A non-limiting example of this process may be first obtaining consent from a customer using Shopify, to allow for marketing via electronic communication such as, but not limited to, email and SMS messaging. The consent may include multiple SaaS platforms, such as, but not limited to, Shopify and Sales Force. The synchronization module 500 (FIG. 1) then queries the Shopify platform and determines that consent was provided. With confirmation of consent, the synchronization module 500 (FIG. 1) then sends a communication to the Sales Force platform instructing it that the customer has consented to electronic communication, resulting in Sales Force changing a status of the customer within its records from being a lead without authorization for using electronic communication, to being a lead that has provided consent for electronic communication, such as via electronic marketing campaigns. This process alleviates the need for Sales Force to obtain customer consent for electronic communication, thereby decreasing chances of the customer disagreeing to electronic communication or removing electronic communication authorization.

In accordance with an alternative embodiment of the invention, since the synchronization module 500 (FIG. 1) already has stored thein levels of consent of specific parties/customers as received from the first party site-owner declarations, including levels of consent specific to SaaS platforms 2A, 2B, 2C, transmitting of the customer consent from the first SaaS platform 2A (FIG. 1) to other SaaS platforms, may include customer consent information not only received from the first SaaS platform 2a (FIG. 1), but also received from the first party site-owner declarations, as processed and stored within the synchronization module 500 (FIG. 1).

FIG. 4 and FIG. 5 are flowcharts illustrating steps taken by the synchronization system 500 (FIG. 1) during providing of marketing consent synchronization, when authorization of a customer changes.

As illustrated by FIG. 4, the synchronization system 500 (FIG. 1) receives customer order change notifications from the SaaS providers 2A, 2B, 2C (FIG. 1), as shown by blocks 410A, 410B, and 410C. The customer order change notification can be a new electronic mail authorization for a SaaS provider 2A, 2B, 2C or changing from allowing electronic mail to no longer wanting to receive electronic mail notifications. This customer order change notification may also be a change in level of authorization within a SaaS provider 2A, 2B, 2C, as previously mentioned. While FIG. 4 shows the first, second, and third SaaS providers providing subscriber updates, the updates are not required to be transmitted or received from the different SaaS providers at the same time.

Customer contact details and marketing consent information are extracted from the subscriber updates, also referred to as customer order change notifications (block 420). As shown by block 430, the customer contact state is updated and changed data is captured by the synchronization module 500 (FIG. 1). The customer contact state includes the details and information of the customer that were extracted (previously mentioned block 420). The details and information may be stored within the synchronization system 500 (FIG. 1) storage device 504 (FIG. 1) and processed by the synchronization system 500 (FIG. 1) so that customer records within the synchronization system 500 (FIG. 1) are accurate and up to date with the latest SaaS provider authorizations for electronic communication authorization and level of authorization.

In accordance with one embodiment of the invention, a double-authorization may be required. In such situations, the synchronization system 500 (FIG. 1) queries as to whether the customer/subscriber consented to electronic communication, for example, consenting to electronic mail and/or SMS messaging (block 440).

If the customer, also referred to herein as a subscriber, consented to electronic messaging, an electronic messaging marketing campaign is sent (block 450), after which the subscriber receives an electronic communication (block 452), such as an email, which allows the subscriber to unsubscribe to the associated SaaS platform 2A, 2B, 2C (FIG. 1) if they wish. The synchronization system 500 (FIG. 1) then determines whether the subscriber unsubscribed (block 454). As shown by block 456, if the subscriber unsubscribes, the unsubscribe request is processed by the synchronization system 500 (FIG. 1). In addition, if previously, the subscriber did not consent to electronic communication, processing of an unsubscribe event takes place. Processing of the unsubscribe event and processing of an unsubscribe request includes the synchronization system 500 (FIG. 1) changing status of a customer record therein from authorization for electronic communication to no authorization for electronic communication. In addition, it is noted that instead of unsubscribing, a customer may instead decide to change its level of consent, resulting in processing of the unsubscribe event instead being a change in level of consent storage within the customer record of the synchronization system 500 (FIG. 1).

Referring to FIG. 5, which is a continuation of FIG. 4, a determination is made as to whether different SaaS providers have an interest in subscriber consent changes (block 460). SaaS providers may notify the synchronization system 500 (FIG. 1) if such interest, which is stored by the synchronization system 500 (FIG. 1).

For the SaaS providers that have specified an interest in subscriber consent changes, the synchronization system 500 (FIG. 1) then sends a communication to determine if the subscriber record exists in SaaS provider platforms 2A, 2B, 2C (block 470A, 470B, 470C). As shown by block 480A, 480B, 480C, if the subscriber record does exist within the SaaS provider platform 2A, 2B, 2C (FIG. 1), the synchronization system 500 (FIG. 1) provides notification of consent change to that SaaS provider via the associated SaaS provider platform 2A, 2B, 2C. This process minimizes the need for each SaaS platform sending electronic communication authorization requests to customers.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

We claim:

1. A computer-based method for providing electronic communication marketing consent synchronization across multiple third party Software as a Service (SaaS) integrations, comprising the steps of:
a synchronization module communicating with a first SaaS platform requesting a list of customers that have authorized electronic communication with the first SaaS platform, wherein the list of customers includes for at least one customer a level of consent to electronic communications from the first SaaS provider;
the first SaaS platform transmitting the list of customers to the synchronization module; and
the synchronization module transmitting the customer consent received from the first SaaS platform to at least one other SaaS platform.
